(19) United States
(12) Patent Application Publication
(10) Pub. No.: US 2004/0182778 A1
(43) Pub. Date: Sep. 23, 2004

(54) Airlift pump in a mechanical clarifier

(76) Inventor: Patrick William Hanlon, Sunman, IN (US)

Correspondence Address: Patrick W. Hanlon, 19992 N. Manchester Rd., Sunman, IN, 47041, US

(21) Appl. No.: 10/393,171

(22) Filed: Mar. 20, 2003

(51) Int. Cl. B01D 21/02

(52) U.S. Cl. 210/524; 210/528

(57) ABSTRACT

Described herein is an improved method for removing settled solids from a clarifier tank. The process is performed by utilizing an open pipe for an airlift pump that extends from the top to the bottom of the tank; the said airlift pipe also acts as the drive shaft, support and attachment to the scrapper mechanism which rotates at the bottom of the tank and moves the settled solids toward the center drawoff well; the said drive shaft/airlift pump into which air is introduced to transport the liquid and solids at the bottom up to the discharge; said pump extends through the mechanical drive mechanism presenting an unimpeded path for the liquid flow up through the drive and out the top into a discharge trough to be directed away or recycled; the said mechanical drive imparts a turning moment onto the drive shaft/airlift pump to rotate the scrapper; the same drive mechanism is so configured to incorporate the drive shaft/airlift pump to allow the unimpeded flow path through it; therein the improvement is utilizing a multifunctional drive shaft/airlift pump configured to be incorporated into and driven by the mechanical drive mechanism for scrapping the settled solids at the bottom of the tank, using an airlift pump mechanism for removal of these settled solids in a way that simplifies, enhances and remedies problems of pumping the settled solids from a clarifier.

### BACKGROUND OF THE PATENT

Removing settled material from a clarification process tank has been handled in numerous ways since the use of these solids collection devises. The removal of the bottom sludge has been the subject of much attention. Prior art of continuous removal of settled solids has been accomplished by using airlift pumps since the early 1900's. The present invention is a specific improvement to a circular configuration clarifier mechanism. Refinements are shown by Weinig U.S. Pat. No. 2,262,412 where the sludge is scraped to an opening in the bottom of the tank. Forrest U.S. Pat. No. 3,396,102 applies an airlift pump both in a rectangular and circular pattern. However in the circular arrangement the airlift pump is offset from the center of the tank by some distance. The airlift pump is supported from the drive shaft by brackets and discharges horizontally beyond the periphery of the clarifier. Further refinement by Hampton U.S. Pat. No. 3,722,698 describes a mechanically driven scrapper. However, the separate multiple airlift pumps are only attached by supports to the drive shaft. Drewery U.S. Pat. No. 6,106,704 describes a fixed position arrangement. Notwithstanding, the present art in circular tank sludge removal has evolved to using horizontal draw-off pipes connected to a sludge well and then to centrifugal pumps to lift the solids out of the clarifier. There are some inherent limitation, maintenance and higher cost issues associated with this arrangement. Eliminating the horizontal draw-off pipes precludes the potential for these to plug with high solids accumulation. The costly installation of centrifugal pumps, with their ancillary equipment is also eliminated with the disclosed design.

### BRIEF SUMMARY OF THE INVENTION

Mechanically driven scrappers have been applied in clarifiers for many years. Airlift pumps have likewise, been around since the 1800's. The present invention unabashedly utilizes these proven technologies in a way that improves the continuous removal technique of settled solids in the clarification process. Attention is directed to the mechanical drive that is used to push the scrapper that moves the solids at the bottom of the tank into the sludge well. The mechanical drive imparts a turning moment onto the shaft of the scrapper mechanism. The said shaft, also, acts as the piping housing for the airlift pump. The utilization of the drive shaft/airlift pipe in this dual-purpose configuration facilitates a vertical straight passage of the water, solids and air in the most viable way. What is disclosed here is a method of pumping solids that accumulate in the bottom of a clarifier tank in a more efficient and cost effective method. This disclosed method simplifies pumping of solids and includes:

A clarifier mechanism that incorporates the state-of-the-art mechanical drive by facilitating a through drive shaft/airlift pipe that extends from the sludge well in the bottom of the tank up through the said drive to discharge above it;

Said drive shaft/airlift pipe serves the dual-purpose of supporting and turning the scrapper mechanism and acts as the housing through which is pumped the fluid, solids and air;

In other configurations the airlift pump may be separate from the scrapper support mechanism and simply extend from the sludge well up through and incorporated with the drive mechanism;

Said airlift pump is connected with a supply of air to facilitate the lifting mechanism for pumping: and

Wherein the improvement is characterized by simplifying the configuration of equipment, reducing the civil design, lowering the cost of pumping, reducing the maintenance of the pumping process and improving the process control capability of pumping settled solids from the clarifier.

### BRIEF DESCRIPTION OF THE DRAWINGS

FIG. 1 is a schematic depiction of the disclosed mechanism and pumping process for a clarifier with a mechanical drive that incorporates a dual-purpose drive shaft/airlift pump design.

FIG. 2 is a schematic depiction of the disclosed mechanism and pumping process for a clarifier with a mechanical drive that incorporates an airlift pump independent of sludge scrapper mechanism.

FIG. 3 is a schematic depiction of the disclosed mechanism and pumping process for a clarifier with a mechanical drive that incorporates a mixer and a dual-purpose drive shaft/airlift pump.

### DETAILED DESCRIPTION OF THE INVENTION

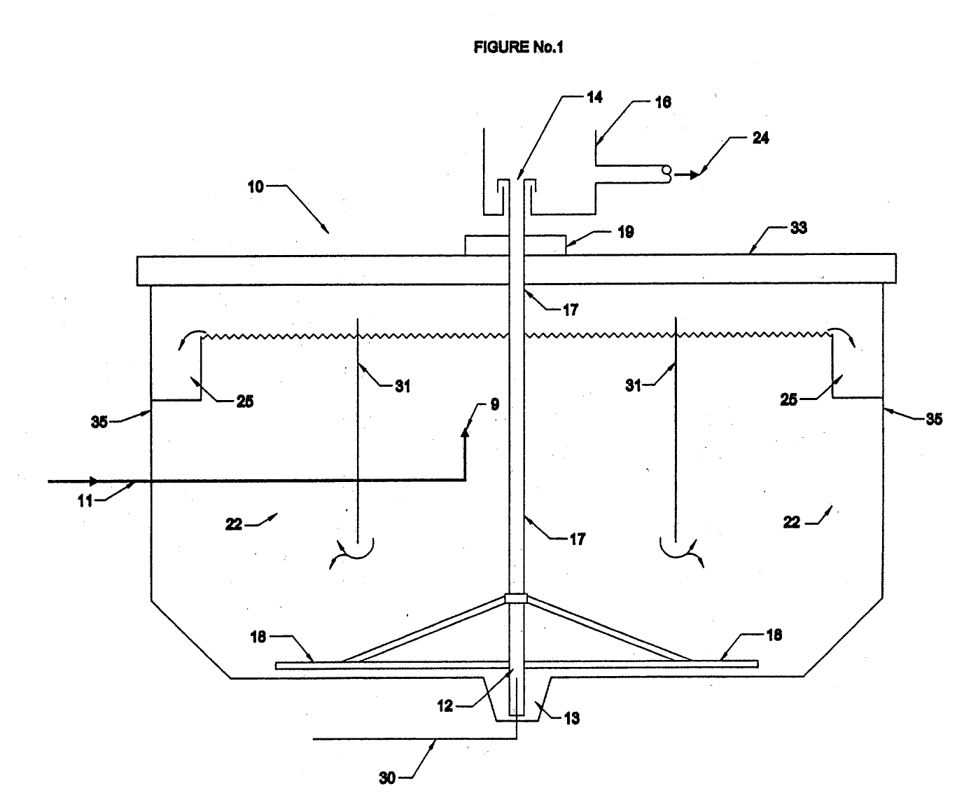

Referring to the schematic representation of the disclosed mechanisms and pumping process as depicted in FIG. 1, the reader is directed to the influent pipe 11 introducing the fluid to be clarified by the system 10. This stream is typically ladened with solids and contaminants that are intended to be removed in the clarification process and continuously pumped out to waste or further treatment or recycle.

The fluid enters the center of the clarifier at 9 and then is directed by the center well baffle 31 down to the quiescent settling zone 22 where the solids gravitate downward and the clarified fluid moves upward to be collected at the launder 26 and discharged. The settled solids migrate to the bottom and are directed by the rotating sludge scrapper mechanism 18 toward the center and to the sludge well 13. The scrapper mechanism is attached to the drive shaft 17 which is attached to the drive mechanism 19. The drive mechanism imparts the turning moment onto the drive shaft and scrapper mechanism. The solids fall into the sludge well where the airlift pipe, also 17, protrudes into the well. Notice that now the drive shaft and the airlift pipe are the same and perform a dual-purpose as the drive shaft/airlift pump 17.

An airline 30 is placed into the airlift pump and air is introduced at 12 to create the lift to carry the liquid, solids and air up the drive shaft/airlift pump. The open piping carries the mass directly upward, unimpeded to be discharged at 14. The fluid, solids and air overflow the pump into a catch box 16 and are then directed to a desired location 24 in the process stream. The mechanical drive 19, the drive shaft/airlift pump 17 and the scrapper mechanism 18 are supported by beams 33 that set on the walls 35 of the clarifier.

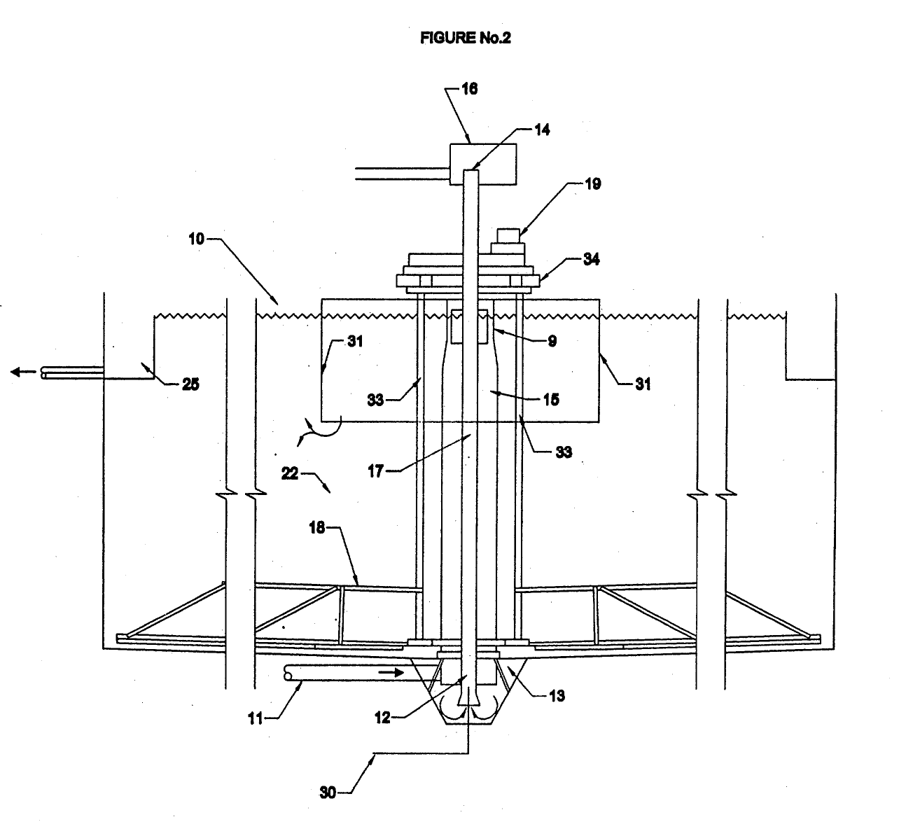

In the circumstance of a larger clarifier, FIG. 2 would depict the embodiments of the disclosure. Notice the influent solids ladened stream 11 enters at the bottom of the riser support column 15 and discharges at the top of the column at 9. The riser column supports the whole rotating collector mechanism. The fluid and solids flow down and under the center well baffle 31 into the quiescent separation zone 22. In the separation zone the clarified liquid flows upward and over the launder weir 25 and is discharged from the system 10. The settleble solids gravitate downward and settle at the bottom where they are directed by the rotating sludge scrapper mechanism 18 and are plowed to the sludge well 13.

The airlift pump piping 17 protrudes into the sludge well and then upward into and through the mechanical drive mechanism 19. An air supply pipe 30 is inserted into the airlift pump and introduces air at 12 to activate the pumping. The air bubbles formed carry the liquid, the solids and the air directly and unimpeded vertically through the airlift pump 17 to be discharged at 14. The concentrated solids mixture overflows into the catch box 16 and is directed to discharge. A continuous pipe (not shown), configured to match up with the airlift pump piping to direct the discharge flow away, would also be viable. The scrapper mechanism 18 is connected to and supported from the rake cage 33. The rake cage is attached to the rotating portion 34 of the mechanical drive mechanism 19.

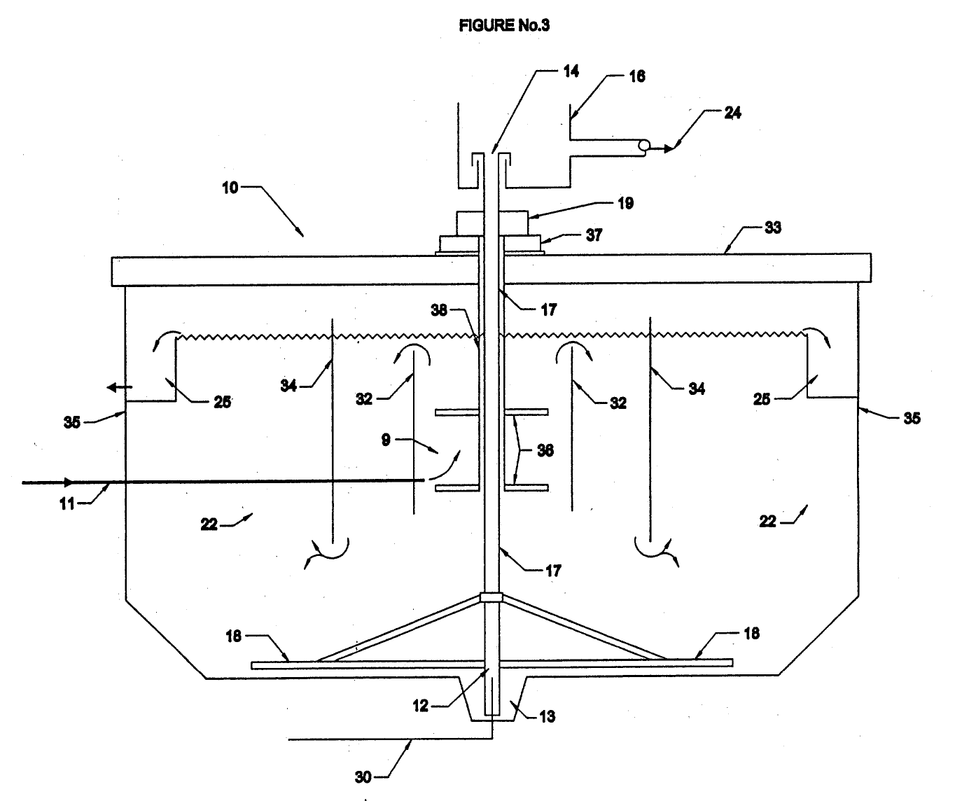

The depiction in FIG. 3 is very similar in process to that in FIG. 1 except for the addition of a radial mixer 36. The mixer blades are attached to a shaft 38 and powered by a mechanical drive 37 that imparts the turning moment. The scrapper drive shaft/airlift pump 17 is configured to rotate within the shaft of the mixer 38. The influent 11 enters the system at 9 and is directed by the internal baffle 32 and the said mixer direct the flow up and over the baffle 32. The outer baffle 34 directs the flow down and under the baffle 34. All other mechanisms are as described in FIG. 1.

To summarize, again, the system of this disclosure offers an easier method for the continuous pumping of settled solids from a clarification process. The disclosed method embodies equipment that configures the drive mechanism to allow the airlift pump piping to be incorporated into and through the said drive mechanism. By this configuration an unimpeded flow pattern that allows the airlift devise to remove the settled solids in a simpler, more reliable method than is in practice today for removing and pumping settled solids from clarifier basins. Today practice requires a long horizontal run of piping from the sludge well to the centrifugal pumps. The horizontal pipe and the centrifugal pumps are a less than ideal method for removing solids but are a better alternative to other practice of art in pumping. The present disclosure eliminates most of the handicaps in solids pumping and employs simpler proven technology by reconfiguring the center drive mechanism.

While the foregoing is a complete and detailed description of the preferred embodiments of the disclosed system, numerous variations may also be employed to implement the all-important purpose of the invention without departing from the spirit of the invention; and therefore the elaboration provided should not be assumed to limit, in anyway, the scope of the invention which is fairly defined by the appended claims.

What is claimed:

1. In a improved pumping system for removing settled solids from a clarification process, said system comprising:
means for introducing solids ladened liquor into a clarification tank with walls and a bottom; means for the flow to be directed to a quiescent zone to allow the settling of solids; means to rotate a scrapper mechanism to move the settled solids; means to incorporate an airlift pump with the mechanical drive mechanism; means to collect the settled solids into a sludge well; means to provide an airlift pump to the sludge well; means to provide an unimpeded flow pattern up through the mechanical drive; means to supply and control air into the airlift pump; and means to receive the pumped mass and to direct it to further discharge.

1. The improved pumping method according to claim 1 wherein a mixer and a drive shaft/airlift pump is incorporated into the mechanical drive mechanism.

2. The improved pumping method according to claim 1 wherein the open drive shaft acts as the suction pipe for motive action of the solids by other mechanical means, i.e. a centrifugal pump or the like.

3. The improved pumping method according to claim 1 wherein the airlift pump does not extend into a sludge well but picks up the solids as they are concentrated on the bottom of the said clarifier tank.
